(19) United States
(12) Patent Application Publication
(10) Pub. No.: US 2008/0313720 A1
(43) Pub. Date: Dec. 18, 2008

(54) System, Device and Method for Conducting Secure Economic Transactions

(76) Inventor: Adam Boalt, West Palm Beach, FL (US)

Correspondence Address: MAYBACK & HOFFMAN, P.A., 5722 S. FLAMINGO ROAD #232, FORT LAUDERDALE, FL, 33330, US

(21) Appl. No.: 11/764,545

(22) Filed: Jun. 18, 2007

(51) Int. Cl. H04L 9/32

(52) U.S. Cl. 726/6; 726/5

(57) ABSTRACT

An identification verification device includes an input operable to receive an identification verification query relayed by an account hosting entity. The identification verification query includes a temporary code received from a user. A comparator is coupled to the input and is operable to compare the received temporary code with a verification code. An output transmits to the account hosting entity one of an authorized and a not authorized response that is based upon the comparison.

### CROSS-REFERENCE TO RELATED APPLICATIONS

This patent application is related to U.S. patent application Ser. No. 11/256,441, Attorney Docket Number 1702-P0001, filed on Oct. 24, 2005, and U.S. patent application Ser. No. 11/682,659, Attorney Docket Number 1702-P0002, filed on Mar. 6, 2007, the entire disclosures of each are herein incorporated by reference.

### FIELD OF THE INVENTION

The present invention relates generally to secure transactions, and more particularly relates to a single pass code that can be used to access multiple independent pass-code protected accounts.

### BACKGROUND OF THE INVENTION

An exponential increase in electronic commerce has taken place since the advent of the Internet and the general affordability of the personal computer. Unfortunately, there has also been a proportionate amount of persons that have dedicated considerable resources to fraudulently accessing these commerce streams. To combat this invasive force, institutions are constantly installing measures to better protect their account holders and to counter the intruder's attempts to defraud the account holders and the institution.

By far the most widely spread security measure—used by almost all account hosting institutions—is password protection. A password is a form of secret authentication data that is used to control access to a resource. The password is kept secret from those not allowed access, and those wishing to gain access are tested on whether or not they know the password. Access is granted or denied accordingly.

The use of passwords goes all the way back to ancient times. Sentries guarding a location would challenge for a password and would refuse entry (or worse) to those that did not know the password. In modern times, passwords are used to control access to protected computer operating systems, mobile phones, automated teller machines (ATMs), email accounts, bank accounts, memberships, investment accounts, work accounts, school accounts, and many others.

Unfortunately, once a third party determines a user's password, that third party can gain access to the user's account and/or confidential information. This problem is compounded by the fact that most users register a single password on multiple accounts to avoid having to remember multiple passwords. Once that password is intercepted, multiple accounts are at risk.

A relatively new technology designed to overcome the problems just mentioned is rolling or random code generation and authentication devices. On the user's side is a code generator that produces a temporarily valid authentication code. The user enters the code and transmits it to the institution that issued the generator. On the institution side, a server receives the code and authenticates that code based on either a time of day, an underlying secret algorithm for generating the code, or both. If the code is received again or if a specified amount of time passes before the code is entered, it is refused. Advantageously, use of one-time codes for authentication ensures that even if a code is intercepted, a defrauder will either not be able to use it with a timeframe that it is valid (e.g., 60 seconds) or will only be able to enter it after the user's initial transmission of the code and will be denied access for being the second attempt to use a one-time code.

However, each pass-code generator device has a size, weight, cost, and inconvenience of use associated with it. Users with multiple accounts must carry with them and manage multiple pass-code generators, which is burdensome and inconvenient. It is also expensive for an institution to provide these devices to each of their account holders.

Therefore a need exists to overcome the problems with the prior art as discussed above.

### SUMMARY OF THE INVENTION

Briefly, in accordance with the present invention, disclosed is a secure economic transaction system in the form of an account-information-generating device, capable of generating information that is valid only for a pre-determined amount of time, in conjunction with an account-information authenticating entity that is able to authenticate the temporarily valid or one-time use information. A subscribing, or participating, third party that wishes to conduct secure transactions with users receives the generated information and, instead of validating the information itself, sends the information to an account-information authentication entity for verification that the account information is valid. Advantageously, users no longer have to carry a separate code generator for each account, but can, instead, use a single device to access all of their accounts. Institutions no longer have to supply their account holders with code generation devices because they are now able to subscribe to a service that uses a single code-generating device.

In accordance with a feature of the present invention, one embodiment includes an identification verification device with an input operable to receive an identification verification query relayed by an account hosting entity, the identification verification query includes a temporary code received from a user, a comparator coupled to the input and operable to compare the received temporary code with a verification code, and an output for transmitting to the account hosting entity one of an authorized and a not authorized response that is based upon the comparison.

In accordance with a further feature, an embodiment of the present invention includes a memory for storing a code-generation algorithm and a processor coupled to the memory and operable to generate the verification code by performing the algorithm.

In accordance with a further feature of the present invention, the temporary code is valid only for a finite amount of time and the temporary code is valid only for a single use.

In accordance with another feature, an embodiment of the present invention includes a memory for storing previously received temporary codes, wherein the comparator is operable to compare the received temporary code to one or more of the previously received temporary codes stored in memory.

In accordance with the present invention, a method for verifying an account is also disclosed, where the method includes receiving an account access request from a user, the account access request including a temporary code, sending at least a portion of the temporary code to an account verifying entity, receiving an authentication response from the account verifying entity based upon a comparison of the at least a portion of the temporary code to a verification code held by the account verifying entity.

In accordance with the present invention, a further method for verifying an account is disclosed, where the method includes receiving at least two account verification queries each relayed by a different one of at least two account hosting entities, each account verification query including a same temporary code received from a user, comparing the received temporary code with a verification code, and communicating to each of the account hosting entities one of an authorized response and a not authorized response dependent upon a result of the comparison.

In accordance with the present invention, yet another method for verifying an account is disclosed, where the method includes receiving an account verification query relayed from a first account hosting entity, the account verification query including a first temporary code received from a user, receiving an account verification query relayed from a second account hosting entity, the account verification query including a second temporary code received from the user, verifying a validity of the first and second received temporary codes, and communicating to each of the account hosting entities one of an authorized response and a not authorized response dependent upon a result of the validity verifying step.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of a distributed data processing system in which the present invention may be implemented.

FIG. 2 is a block circuit diagram of a data processing system that may be implemented as a server computer system, such as Validation Server 104 or Account Hosting Entity 101 shown in FIG. 1, in accordance with an embodiment of the present invention.

FIG. 3 is a block circuit diagram of a data processing system that may be implemented as a client computer system, such as Client Terminal 108 shown in FIG. 1, in accordance with an embodiment of the present invention.

FIG. 4 is a diagrammatic illustration of a front face of an exemplary embodiment of a temporary code generator device in accordance with the present invention.

FIG. 5 is a block diagram of an exemplary back face of the temporary code generator device of FIG. 4 in accordance with the present invention.

FIG. 6 is a process flow diagram of a temporary number generation and verification process in accordance with an exemplary embodiment of the present invention.

FIG. 7 is a block diagram of a detailed view of a computing system, according to an exemplary embodiment of the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The present invention, according to an embodiment, overcomes problems with the prior art by providing a secure economic transaction system in the form of an account-information-generating device that is capable of generating information that is valid only for a pre-determined amount of time and an account-information authenticating entity that is able to authenticate the temporarily valid or one-time use information. A subscribing, or participating, third party that wishes to conduct secure transactions with a user receives the generated information and, instead of validating the information itself, sends it to an account-information authentication entity for verification that the account information is valid. Unauthorized account access is thereby thwarted because a third party that is able to intercept the account information will not have enough time to use the information before at least a portion of the intercepted account number expires. In addition, users no longer have to carry a separate code generator for each account, but can, instead, use a single device to access all of their accounts that are participating with the present invention. Furthermore, in the event of a lost or stolen code generation device, only a single entity needs to be contacted to stop authentication of the codes generated by the lost or stolen device.

Described now is an exemplary hardware platform for use with embodiments of the present invention.

Network

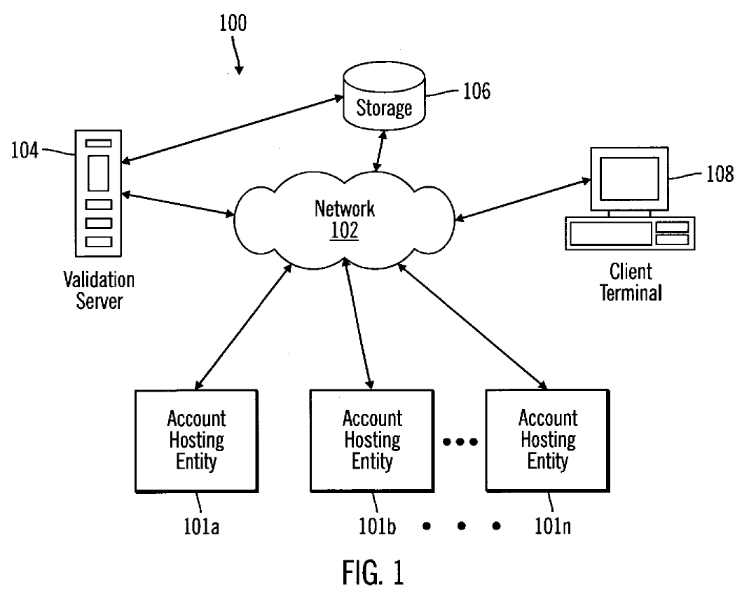

With reference now to the figures, FIG. 1 is a pictorial representation of a network data processing system in which the present invention may be implemented. Network data processing system 100 contains a network 102, which is the medium used to provide communication links between various devices and computers connected together within the network data processing system 100. The network 102, can be, for example, the Internet, and may include wired or wireless connections. A few exemplary wired connections are cable, phone line, and fiber optic. Exemplary wireless connections include radio frequency (RF), microwave frequency, and infrared radiation (IR) transmission. Many other wired and wireless connections are known in the art and can be used with the present invention.

In the depicted example, a server 104, a Client Terminal 108, and one or more Account Hosting Entities 101a-n are connected to and through the network 102. A storage unit 106 may also be connected to server 104 or any of the other components through network 102 in a Network File System (NFS) configuration, or may be, alternatively, coupled directly to server 104 or one of the other components.

Network data processing system 100 may include additional servers, clients, and other devices not shown. In the depicted example, network data processing system 100 includes the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Server/Account Hosting Entity

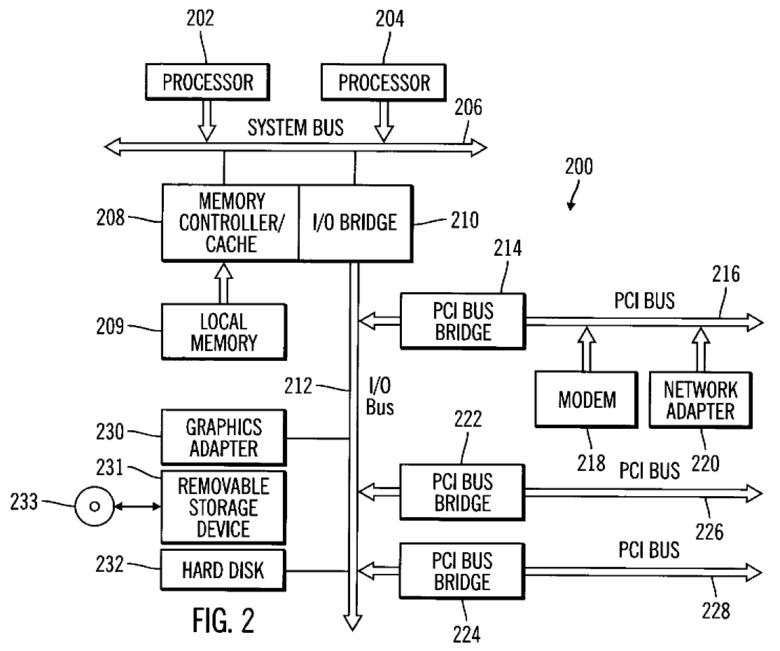

Referring to FIG. 2, a block diagram of a data processing system that may be implemented as a server 104, which, in an embodiment of the present invention, is an entity that performs access number validations. The data processing system of FIG. 2 may also be implemented as the Account Hosting Entity 101, shown in FIG. 1. Data processing system 200 may be a single processor system including a processor 202 or can be a symmetric multiprocessor (SMP) system including a plurality of processors 202 and 204 connected to and by a system bus 206. Also, connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted. The processor 202 or 204 in conjunction with memory controller 208 controls what data is stored in memory 209 and can retrieve data from memory, for example, for comparing to pieces of data, where the processor performs the functions of a comparator.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to one or more network computers 108 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

Computer programs (also called computer control logic) are stored in memory. Computer programs may also be received via communications interface 216. Such computer programs, when executed, enable the computer system to perform the features of the present invention as discussed herein. In particular, the computer programs, when executed, enable the processor 202 and/or 204 to perform the features of the computer system. Accordingly, such computer programs represent controllers of the computer system.

In this document, the terms “computer program medium,” “computer usable medium,” and “computer readable medium” are used to generally refer to media such as main memory 209, removable storage drive 231, removable media 233, hard disk 232, and signals. These computer program products are means for providing software to the computer system. The computer readable medium allows the computer system to read data, instructions, messages or message packets, and other computer readable information from the computer readable medium. The computer readable medium, for example, may include non-volatile memory, such as floppy, ROM, flash memory, disk drive memory, CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network, that allow a computer to read such computer readable information.

Account Access

Each of the Account Hosting Entities 101a-n represents a company, individual, or other entity that hosts or otherwise protects a database of information that is accessible via a network 100 and is protected by an account verification measure, namely temporary access codes. With temporary access code protection, a user is provided with a device that, upon being prompted, produces a number or a code. The number or code is based on an algorithm, as will be explained below. Generally, either a reference, such as a value or time, that the algorithm uses or the algorithm itself is a secret and known only to the Account Hosting Entity. Without the secret code, a requesting user will be denied access to the entity 101.

Temporary codes and their generation will be discussed more in detail below; however, it is important to recognize that embodiments of the present invention hand off the code verification duties to a separate entity, namely the remote Validation Server 104. Therefore, advantageously, Account Hosting Entities utilizing the advantages of the present invention no longer have to burden their resources with the actual execution of the verification process, but instead pass it along to a third party.

Temporary Number Generation

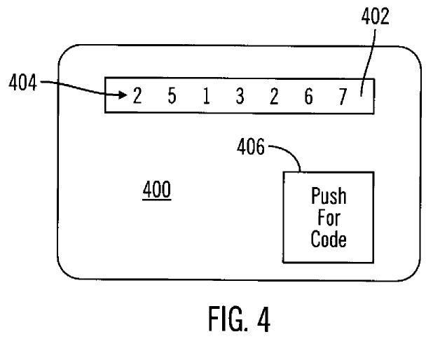

FIG. 4 shows one exemplary embodiment of a temporary number generator (TNG) 400. In this particular embodiment, the TNG 400 is part of or integrated into a credit card sized device, although the invention is not limited to any particular embodiment. The TNG 400 shown in FIG. 4 is a credit card provided with a display 402. The display 402 can be a liquid crystal display (LCD), which is well known to those of average skill in the art. LCDs are thin, flat display devices made up of any number of color or monochrome pixels arrayed in front of a light source or reflector. LCDs have very low power requirements, and are therefore well suited for use in battery-powered electronic devices, such as the card sized TNG 400. The LCD display 402 can be made of materials such as organic thin-film transistors, electrophoretic plasma, organic light emitting diodes, and others. The invention, however, is not limited to any particular type of display.

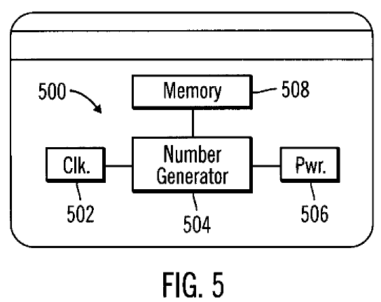

The numbers 404 shown on and by the display 402 are generated by number generation circuitry 500 diagrammatically illustrated in FIG. 5. The number generation circuitry 500 includes a number generator 504, a power source 506, a memory 508, and a clock 502. The circuitry 500, in one embodiment, operates in response to a signal generated when a button 406 (shown in FIG. 4) is depressed. The circuitry 500 then produces a temporary code or access number 404.

In one embodiment of the present invention, the access number 404 is generated through use of one or more symmetric-key algorithms. Symmetric-key algorithms are a class of algorithms for cryptography that use trivially related cryptographic keys for both decryption and encryption. The encryption key is trivially related to the decryption key, in that they may be identical or there is a simple transform to go between the two keys. The keys, in practice, represent a shared secret between two or more parties that can be used to maintain a private information link. In this case, the account holder and the entity operating the Validation Server 104 are the two parties sharing the secret, which is the user's account information. The invention, however, is not limited to any particular method or algorithm for generating the access number 404 or comparison, validation, or authentication of numbers. What is necessary is that the verifying entity is able to decode or otherwise understand the access number 404 generated by the TNG 400 and verify the account to which the user is associated.

In one embodiment, the code 404 is generated by an algorithm that produces a number based on a timer, such as a time of day. That is to say, the number generation circuitry 500 uses the current time of day, or simply a time value, provided by the clock 502, to generate the number 404. The number 404 is a valid number for authorizing access and/or a transaction linked to the user's account, but is only valid for a finite amount of time. Upon expiration of the finite amount of time, a new number 404 is generated The access number or code 404 can be made of numbers, characters, symbols, or a combination thereof. The number generation circuitry 500 of the present invention can be realized in hardware, software, or a combination of hardware and software. A typical combination of hardware and software could be a general microprocessor with a computer program that, when executed, carries out the number generation methods described herein. Access number generation is described in co-pending U.S. patent application Ser. No. 11/256,441, filed on Oct. 24, 2005, the entire disclosure of which is hereby incorporated herein by reference.

Client Terminal

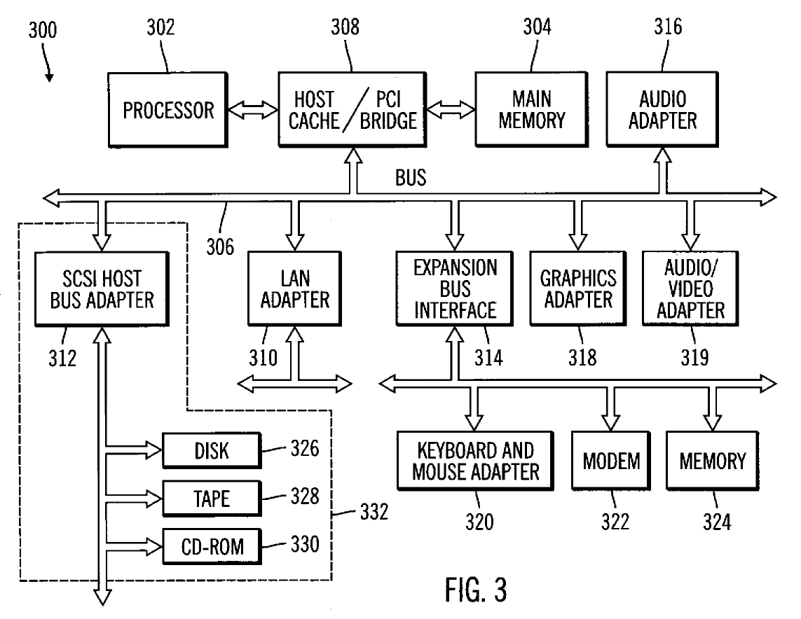

The Client Terminal 108 provides an input to the network 100 in which a user can enter and transmit a temporary code 404 to an Account Hosting Entity 101, who, as is explained in the following section, relays the code to the Validation Server 104 for authentication of the code. With reference now to FIG. 3, a block diagram illustrating a data processing system useful for implementing the Client Terminal 108 is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. Each client is able to execute a different operating system. The operating system may be a commercially available operating system, such as Windows XP, which is available from Microsoft Corporation. A database program such as ORACLE may run in conjunction with the operating system and provide calls to the operating system from JAVA programs or applications executing on data processing system 300. “Oracle” is a trademark of Oracle, Inc. and “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device or other light client which is configured with ROM and/or flash ROM in order to provide non-volatile memory for storing operating system files and/or user-generated data. The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a World Wide Web appliance.

Transmission to Account Hosting Entity

Embodiments of the present invention advantageously relieve the Account Hosting Entities 101 of the responsibility and overhead of verifying access codes, as is currently performed in the art. Perhaps an even greater advantage is realized by the users, who are now able to access multiple independent and unassociated secured accounts by using only a single TNG 400.

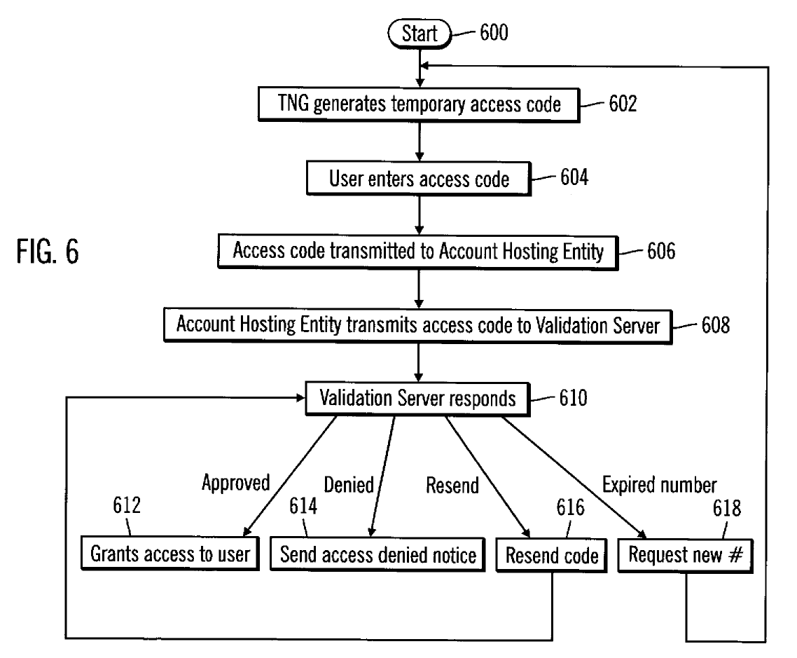

FIG. 6 is a process flow chart showing one exemplary embodiment of the present invention. The flow starts at step 600 and moves directly to step 602 where a user employs a TNG 400 to generate a temporary access code 404. In step 604, the user employs a Client Terminal 108 to enter account identifying information, such as a user name, password, account number, or others, as well as the temporary number 404 within a pre-defined time period in which the temporary number is valid. In step 606, the temporary number 404 is transmitted through the network 102 to an Account Hosting Entity 101. The Account Hosting Entity 101, in turn, transmits at least the temporary number 404 to the Validation Server 104 in step 608 for authentication of the temporary number 404. In one embodiment, the access number 404 is transmitted to the Validation Server 104 along with the user's account number, a serial number associated with a credit card, or any other user or account identification information. When the access number 404 is generated by the TNG 400 and transmitted to the Validation Server 104, the Validation Server 104 can look up the account number and then compare the access number 404 to its generated access number to determine authorization. In one embodiment, the access number 404, e.g., symmetric-key algorithm, is based on time. When implementing this time-of-day based algorithm, the Validation Server 104 and the TNG 400 both use a time-of-day to generate the access number 404. Both the account authorizing entity 104 and the TNG 400 are able to be synchronized by using synthesized time-of-day clocks. Therefore, the account authorizing entity 104 will be able to validate any unexpired access numbers 404 transmitted to the account authorizing entity 104. This validation can be through the use of any known or future developed validation methods. After the finite length of time, a new access number 404 must be generated and transmitted to the account authorizing entity 104 or else the transactions will be denied.

The finite amount of time that the code is valid can be configured by various components to vary from 1 second to infinity; however, a practical time of validity is on the magnitude of about 60 seconds. The amount of time that the code is valid should be long enough for a user to enter the code, an Account Hosting Entity 101 to receive it, transmit it to an account verifying entity 104, and allow the account verifying entity 104 to confirm that the code is valid. However, the length of time that the code is valid should be limited so that a code intercepting party will not have sufficient time to also forward a transaction with the same valid access number 404 to the account verifying entity 104.

In step 610, the Validation Server 104 answers with a validation response that can include “approved,” “denied,” “resend,” “expired number,” or other appropriate message. If the response is “approved,” the flow moves to step 612 where the Account Hosting Entity 101 interprets the response and grants access to the user. If the response by the Validation Server 104 is “denied,” the Account Hosting Entity 101, in step 614, sends a notification to the Client Terminal 108 that access is denied. If the response by the Validation Server 104 is “resend,” possibly due to data loss during transmission, the Account Hosting Entity 101, in step 616 resends the temporary access code and the flow moves back to step 610. If the response by the Validation Server 104 is “expired number,” the Account Hosting Entity 101, in step 618, sends a request to the Client Terminal 108 for a new temporary access number 404. The flow then moves back up to step 602 and waits for a subsequent transmission of an access code 404.

Variations of the inventive process shown in FIG. 6 and described above are contemplated. For instance, in one embodiment, the temporary access code 404 is communicated from the Client Terminal 108 directly to the Validation Server 104 along with account or use identifying information so that Validation Server 104 knows where to send a validation response after validating the temporary access number 404. For example, a user could transmit an account code that uniquely identifies a particular Account Hosting Entity 101a-n and the Validation Server 104, by interpreting this account code, automatically knows to send an authorization message to the appropriate Account Hosting Entity 101.

In some embodiments of the present invention, the Validation Server 104 validates a temporary access code 404 by comparing the temporary access code 404 to a value stored in storage area 106, shown in FIG. 1. The value may not be the exact temporary access code 404, but may instead be a value that a secret algorithm uses to build the temporary access code 404. For example, the value may be a base number that a prescribed set of mathematical manipulations are performed on to arrive at the temporary access code 404. In one embodiment, the access number 404, after being received by the verifying entity 104, is discarded from a list of authorizable codes, which may or may not be stored in the storage location 106. In this way, each access code 404 is only valid for a single transaction. Therefore, even if a thief were able to intercept the code number 404 and quickly submit a transaction, the transaction would be denied if the card holder submitted a transaction first. Because the number of possible codes is finite, the one-time code usage may refer to not allowing consecutive uses of the code, but will allow the same code to be used again in the future.

As stated above, the temporary access number 404 may be based on time and valid for only a finite length of time, e.g. 60 seconds. In some instances, there may be a relatively long delay (e.g. several minutes) between the time the temporary access number 404 is generated and the time it is received by the Validation Server 104. In this situation, the Validation Server 104 will deny the transaction due to the number being expired and can simply send a request for the generation of a new number. Going further, embodiments of the present invention allow the Validation Server 104 to compare a second time-based number and determine that the code generator 400 is generating authorized numbers, but its clock is delayed or advanced from the actual time. In this situation, the Validation Server 104 can accept the number as being generated from an authentic authorized code generator 400 or can send a signal to the Client Terminal 108 indicating that the code generator needs to be reset.

In one embodiment of the present invention, the Validation Server 104 keeps track of the number of requests for access that are made using a number that is expired or otherwise invalid. After a specified number of unsuccessful attempts to access an account using the invalid number, the Validation Server 104 can suspend the account until the occurrence of an event, such as passing or a requisite amount of time or response to an email or phone call, or other similar events.

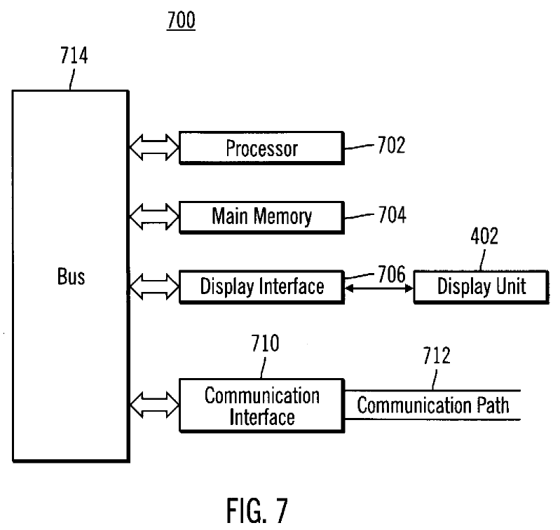

FIG. 7 is a high level block diagram illustrating a detailed view of a computing system 900 useful for implementing the number generation circuitry 504 according to embodiments of the present invention. The computing system 700 is based upon a suitably configured processing system adapted to implement an exemplary embodiment of the present invention.

In one embodiment of the present invention, the computing system 700 includes one or more processors, such as processor 702. The processor 702 is connected to a communication infrastructure 714 (e.g., a communications bus). Various software embodiments are described in terms of this exemplary computer system. After reading this description, it will become apparent to a person of ordinary skill in the relevant art(s) how to implement the invention using other computer systems and/or computer architectures.

The computing system 700 can include a display interface 706 that forwards graphics, text, and other data from the communication infrastructure 714 for display on the display screen 402. The computing system 700 also includes a memory 704, preferably random access memory (RAM), and may also include various caches and auxiliary memory as are normally found in computer systems.

The computing system 700, in this example, includes a communications interface 710 that acts as an input and output and allows software and data to be transferred. Software and data transferred via communications interface 710 are in the form of signals which may be, for example, electronic, electromagnetic, optical, or other signals capable of being received by communications interface 710. The signals are provided to communications interface 710 via a communications path (i.e., channel) 712. The channel 712 carries signals and may be implemented using wire or cable, fiber optics, a phone line, a cellular phone link, an RF link, and/or other communications channels.

Computer programs (also called computer control logic) are stored in memory 704. Computer programs may also be received via communications interface 710. Such computer programs, when executed, enable the computer system to perform the features of the present invention as discussed herein. In particular, the computer programs, when executed, enable the processor 702 to perform the features of the computer system.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

The terms “a” or “an”, as used herein, are defined as one, or more than one. The term “plurality”, as used herein, is defined as two, or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The terms “program”, “computer program”, “software application”, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

What is claimed is:

1. An identification verification device comprising:
an input operable to receive an identification verification query relayed by an account hosting entity, the identification verification query including a temporary code received from a user;
a comparator coupled to the input and operable to compare the received temporary code with a verification code; and
an output for transmitting to the account hosting entity one of an authorized and a not authorized response that is based upon the comparison.

2. The identification verification device according to claim 1, further comprising:
a memory for storing a code-generation algorithm; and
a processor coupled to the memory and operable to generate the verification code by performing the algorithm.

3. The identification verification device according to claim 1, wherein:
the temporary code is valid only for a finite amount of time.

4. The identification verification device according to claim 1, wherein:
the temporary code is valid only for a single use.

5. The identification verification device according to claim 1, further comprising:
a memory for storing previously received temporary codes, wherein the comparator is operable to compare the received temporary code to one or more of the previously received temporary codes stored in memory.

6. The identification verification device according to claim 1, wherein:
the temporary code is a product of a temporary code generator integrated into a credit card.

7. A system for verifying an account user, the system comprising:
a temporary code generator operable to generate a temporary code valid for one of:
only a finite amount of time; and
a finite number of uses;
an account hosting entity hosting an account to which the temporary code allows access and operable to relay at least a portion of the code; and
an account verification entity receiving at least a portion of the temporary code from the account hosting entity and verifying a validity of the temporary code.

8. The system according to claim 7, further comprising:
a memory for storing previously received temporary codes; and
a comparator operable to compare the received portion of the temporary code to one or more of the previously received temporary codes stored in memory.

9. The system according to claim 7, wherein:
the temporary code generator has a housing with a shape and size similar to a standard credit card.

10. The system according to claim 7, further comprising:
a user interface communicatively coupled to the account hosting entity, the user interface for accepting and transmitting the code to the account hosting entity.

11. The system according to claim 7, wherein:
a value of the code is at least partially dependent upon a time of day.

12. The system according to claim 7, wherein:
a value of the code is at least partially dependent upon a symmetric key.

13. A method for verifying an account, the method comprising:
receiving an account access request from a user, the account access request including a temporary code;
sending at least a portion of the temporary code to an account verifying entity;
receiving an authentication response from the account verifying entity based upon a comparison of the at least a portion of the temporary code to a verification code held by the account verifying entity.

14. The method according to claim 13, further comprising:
sending a request to the user for a new temporary code when the authentication response indicates that the temporary code is expired.

15. The method according to claim 13, further comprising:
denying the user access to a new temporary code upon receiving an indication in the authentication response that the temporary code is invalid.

16. A method for verifying an account, the method comprising:
receiving at least two account verification queries each relayed by a different one of at least two account hosting entities, each account verification query including a same temporary code received from a user;
comparing the received temporary code with a verification code; and
communicating to each of the account hosting entities one of an authorized response and a not authorized response dependent upon a result of the comparison.

17. A method for verifying an account, the method comprising:
receiving an account verification query relayed from a first account hosting entity, the account verification query including a first temporary code received from a user;
receiving an account verification query relayed from a second account hosting entity, the account verification query including a second temporary code received from the user;
verifying a validity of the first and second received temporary codes; and
communicating to each of the account hosting entities one of an authorized response and a not authorized response dependent upon a result of the validity verifying step.

18. A method for verifying an account, the method comprising:
receiving from at least two account hosting entities at least two account verification queries, each of the at least two account verification queries including a temporary code received from a user;
separating the temporary code from each of the at least two account verification queries and comparing the received temporary codes with a verification code; and
communicating to each of the account hosting entities one of an authorized response and a not authorized response dependent upon the result of the comparison.
